(19) United States
(12) Patent Application Publication
(10) Pub. No.: US 2011/0176461 A1
(43) Pub. Date: Jul. 21, 2011

(54) DETERMINING CONFIGURATION OF SUBFRAMES IN A RADIO COMMUNICATIONS SYSTEM

(75) Inventors: David ASTELY, Bromma (SE); Stefan Parkvall, Stockholm (SE); Riikka Susitaival, Helsinki (FR)

(73) Assignee: Telefonakatiebolaget LM Ericsson (publ)

(21) Appl. No.: 12/945,554

(22) Filed: Nov. 12, 2010

Related U.S. Application Data
(60) Provisional application No. 61/289,655, filed on Dec. 23, 2009.

(51) Int. Cl. H04J 3/00

(52) U.S. Cl. 370/280

(57) ABSTRACT

The technology disclosed provides the ability for a subframe to be configured as a “flexible” subframe. As a result, at least three different types of subframes in a TDD system may be configured: a downlink (“DL”) subframe, an uplink (“UL”) subframe, and a “flexible” subframe. The use of flexible subframes is determined based on a primary TDD configuration, and in a preferred example, on the existing primary TDD configuration in the network. If there is secondary TDD configuration, flexible subframes may be determined based on both the primary and secondary configurations, e.g., using specific rules. Also, the HARQ feedback timing for downlink (DL) transmissions may be determined based on the secondary TDD configuration. Preferred examples ensure that uplink (UL) feedback does not collide with a flexible subframe used for DL transmission. The technology preferably is compatible with legacy UEs.

### RELATED APPLICATION

This application claims priority from U.S. provisional patent application Ser. No. 61/289,655, filed on Dec. 23, 2009, the contents of which are incorporated herein by reference. This application also relates to commonly-assigned U.S. patent application Ser. No. 12/816,821, filed on Jun. 16, 2010, the contents of which are incorporated herein by reference.

### BACKGROUND

The technology pertains to telecommunications, and particularly, to a frame structure and a method and apparatus for configuring a frame structure.

In a typical cellular radio system, radio or wireless terminals (also known as mobile stations and/or user equipment units (UEs)) communicate via a radio access network (RAN) to one or more core networks. The radio access network (RAN) covers a geographical area which is divided into cell areas, with each cell area being served by a base station, e.g., a radio base station (RBS), which in some networks may also be called, for example, a “NodeB” (UMTS) or “eNodeB” (LTE). A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units (UEs) within range of the base stations.

In some radio access networks, several base stations may be connected (e.g., by landlines or microwave) to a radio network controller (RNC) or a base station controller (BSC). The radio network controller supervises and coordinates various activities of the plural base stations connected thereto. The radio network controllers are typically connected to one or more core networks.

The Universal Mobile Telecommunications System (UMTS) is a third generation mobile communication system, which evolved from the Global System for Mobile Communications (GSM). UTRAN is essentially a radio access network using wideband code division multiple access for user equipment units (UEs).

In a forum known as the Third Generation Partnership Project (3GPP), telecommunications suppliers propose and agree upon standards for third generation networks and UTRAN specifically, and investigate enhanced data rate and radio capacity. The Third Generation Partnership Project (3GPP) has undertaken to evolve further the UTRAN and GSM based radio access network technologies. The first release for the Evolved Universal Terrestrial Radio Access Network (E-UTRAN) specification has issued, and as with most specification, the standard is likely to evolve. The Evolved Universal Terrestrial Radio Access Network (E-UTRAN) comprises the Long Term Evolution (LTE) and System Architecture Evolution (SAE).

Long Term Evolution (LTE) is a variant of a 3GPP radio access technology where the radio base station nodes are connected to a core network (via Access Gateways (AGWs)) rather than to radio network controller (RNC) nodes. In general, in LTE the functions of a radio network controller (RNC) node are distributed between the radio base stations nodes (eNodeB's in LTE) and AGWs. As such, the radio access network (RAN) of an LTE system has what is sometimes termed a “flat” architecture including radio base station nodes without reporting to radio network controller (RNC) nodes.

Transmission and reception from a node, e.g., a radio terminal like a UE in a cellular system such as LTE, can be multiplexed in the frequency domain or in the time domain (or combinations thereof). In Frequency Division Duplex (FDD), as illustrated to the left in FIG. 1, downlink and uplink transmission take place in different, sufficiently separated, frequency bands. In Time Division Duplex (TDD), as illustrated to the right in FIG. 1, downlink and uplink transmission take place in different, non-overlapping time slots. Thus, TDD can operate in unpaired frequency spectrum, whereas FDD requires paired frequency spectrum.

Typically, a transmitted signal in a communication system is organized in some form of frame structure. For example, LTE uses ten equally-sized subframes 0-9 of length 1 ms per radio frame as illustrated in FIG. 2.

In the case of FDD operation (illustrated in the upper part of FIG. 2), there are two carrier frequencies, one for uplink transmission (f_{UL}) and one for downlink transmission (f_{DL}). At least with respect to the radio terminal in a cellular communication system, FDD can be either full duplex or half duplex. In the full duplex case, a terminal can transmit and receive simultaneously, while in half-duplex operation (see FIG. 1), the terminal cannot transmit and receive simultaneously (although the base station is capable of simultaneous reception/transmission, i.e., receiving from one terminal while simultaneously transmitting to another terminal). In LTE, a half-duplex radio terminal monitors/receives in the downlink except when explicitly instructed to transmit in the uplink in a certain subframe.

In the case of TDD operation (illustrated in the lower part of FIG. 2), there is only a single carrier frequency, and uplink and downlink transmissions are separated in time also on a cell basis. Because the same carrier frequency is used for uplink and downlink transmission, both the base station and the mobile terminals need to switch from transmission to reception and vice versa. An important aspect of a TDD system is to provide a sufficiently large guard time where neither downlink nor uplink transmissions occur in order to avoid interference between uplink and downlink transmissions. For LTE, special subframes (subframe 1 and, in some cases, subframe 6) provide this guard time. A TDD special subframe is split into three parts: a downlink part (DwPTS), a guard period (GP), and an uplink part (UpPTS). The remaining subframes are either allocated to uplink or downlink transmission.

Time division duplex (TDD) allows for different asymmetries in terms of the amount of resources allocated for uplink and downlink transmission, respectively, by means of different downlink/uplink configurations. In LTE, there are seven different configurations as shown in FIG. 3. The configurations cover a wide range of allocations from uplink heavy DL:UL ratio 2:3 (Configuration 0) to downlink heavy DL:UL ratio 9:1 (Configuration 5). These configurations are referred to in examples below.

To avoid significant interference between downlink and uplink transmissions between different cells, neighbor cells should have the same downlink/uplink configuration. Otherwise, uplink transmission in one cell may interfere with downlink transmission in the neighboring cell (and vice versa) as illustrated in FIG. 4 where the uplink transmission of the UE in the right cell is interfering with the downlink reception by the UE in the left cell. As a result, the downlink/uplink asymmetry typically does not vary between cells. The downlink/uplink asymmetry configuration is signaled as part of the system information and remains fixed for a long period of time.

Existing TDD networks typically use a fixed configuration where some subframes are uplink and some are downlink. This limits the flexibility in adopting the uplink/downlink asymmetry to varying traffic situations.

One possibility to increase the flexibility of a TDD system, at least in some scenarios, is disclosed in commonly-assigned U.S. patent application Ser. No. 12/816,821 and summarized here. Each subframe (or part of a subframe) belongs to one of three different types: downlink, uplink, and a new type called “flexible.” A downlink subframe is used (among other things) for transmission of downlink data, system information, control signaling, and hybrid-ARQ feedback in response to uplink transmission activity. For example, in LTE Rel-8, the UE monitors the physical dedicated control channel (PDCCH) subframes for scheduling assignments and scheduling grants. Uplink subframes are used (among other things) for transmission of uplink data, uplink control signaling (e.g., channel-status reports), and hybrid-ARQ feedback in response to downlink data transmission activity. For example, in LTE Rel-8, data transmission on the physical uplink shared channel (PUSCH) in uplink subframes is controlled by uplink scheduling grants received on a PDCCH in an earlier downlink subframe. Special subframes in LTE are similar to downlink subframes except they include also a guard period as well as a small uplink part in the end of the subframe to be used for random access or sounding. “Flexible” subframes described in the commonly-assigned U.S. patent application Ser. No. 12/816,821, may be used for uplink or downlink transmissions.

In the commonly-assigned U.S. patent application Ser. No. 12/816,821, a semi-static configuration is used to assign one of the above three types to each subframe as illustrated in FIG. 5. For example, semi-static configuration means, in a non-limiting LTE context, configuration by MAC CE, RRC, or specific RNTI on a PDCCH, and may for example be part of the system information either by explicitly indicating “UL”, “DL”, or “flexible,” or by signaling “DL” and “UL” using an existing signaling message and then introduce an additional signaling message, understandable by new radio UE terminals only, where some subframes are identified as flexible. From a UE perspective, flexible subframes may be treated in a similar way as DL subframes unless the UE has been instructed to transmit in a particular flexible subframe. In other words, flexible subframes not assigned for uplink transmission from a particular UE may be treated as a DL subframe. In an LTE example, the UE monitors several candidate PDCCHs in a flexible subframe. If the control signaling indicates that the UE is supposed to receive downlink data transmission on the PDSCH, the UE receives and processes the PDSCH as in a DL subframe. Similarly, if the control signaling contains an uplink scheduling grant valid for a later subframe, the UE will transmit in the uplink accordingly.

In addition to downlink assignments and uplink scheduling grants, other type of control signaling should be considered. Of particular interest are hybrid-ARQ (HARQ) acknowledgement messages (could be positive or negative) transmitted in one direction in response to data transmission in the other direction. As an example, when the UE in LTE receives a data transmission in a particular subframe from the eNodeB, it will, at a predetermined time, transmit a hybrid-ARQ acknowledgement informing the eNodeB whether the data transmission was successful or not. An example from LTE Rel.8 of acknowledgements transmitted in the uplink in response to downlink data transmission is shown in FIG. 6. Commonly-assigned U.S. patent application Ser. No. 12/816,821 proposes to transmit feedback signaling only in an uplink or downlink subframe and not in flexible subframes.

This application focuses on several problems: how to configure the DL, UL, and flexible subframes in a simple way; how to determine HARQ feedback timing so that it is simple to specify and preferably corresponds to the Rel-8 timing as much as practical; how to handle missing HARQ feedback in some error cases; how to handle other control signaling in addition to HARQ feedback signaling; and when to make DL measurements by the UE. The technology in this application solves these and other problems.

### SUMMARY

The technology disclosed herein provides the ability for a subframe to be configured as a “flexible” subframe. As a result, at least three different types of subframes in a TDD system may be configured: a downlink (“DL”) subframe, an uplink (“UL”) subframe, and a “flexible” subframe. The use of flexible subframes is determined based on a primary TDD configuration, and in a preferred example, on the existing primary TDD configuration in the network. If there is secondary TDD configuration, flexible subframes may be determined based on both the primary and secondary configurations, e.g., using specific rules. Also, the HARQ feedback timing for downlink (DL) transmissions may be determined based on the secondary TDD configuration. Preferred examples ensure that uplink (UL) feedback does not collide with a flexible subframe used for DL transmission. The technology preferably is compatible with legacy UEs.

One aspect of the technology includes a radio network node for use in a radio communications network using time division duplex (TDD) to communicate with user equipment (UE) radio terminals. Electronic circuitry is configured to process data for a frame structure that includes one or more subframes preconfigured as downlink subframe, one or more subframes preconfigured as uplink subframes, and one or more flexible subframes each dynamically allocated to be an uplink subframe in one instance and a downlink subframe in another instance. It also determined how to interpret or use one or more of the flexible subframes based on a primary TDD configuration of the radio communications network. Radio receive circuitry is configured to receive information sent by the radio terminal in a flexible subframe. Radio transmit circuitry is configured to transmit information in a downlink direction using a flexible subframe.

The primary TDD configuration may be a current TDD configuration of the radio communications network and used at least by legacy UE radio terminals. In one example implementation, a grant timing of the primary TDD configuration for uplink subframes. If the radio communications network includes a secondary TDD configuration, the electronic circuitry may determine how to interpret or use one or more of the flexible subframes based on the primary and secondary TDD configurations. The secondary TDD configuration in one example may include more downlink subframes as compared to the primary TDD configuration. In one example implementation, the radio communications system is an LTE system, the primary and secondary TDD configurations are included in the existing TDD configurations for LTE, and the radio network node is an eNodeB.

In a detailed but non-limiting example implementation, a number of subframe handling rules may be followed. If a subframe n is a downlink subframe in the primary and the secondary TDD configuration, then the electronic circuitry is configured to determine that the subframe is a downlink subframe. If the subframe n is an uplink subframe in the primary and the secondary TDD configuration, then the electronic circuitry is configured to determine that the subframe is an uplink subframe. If a subframe n is an uplink subframe in the primary TDD configuration and a downlink subframe in the secondary TDD configuration, then the electronic circuitry is configured to determine that the subframe is a flexible subframe. If a subframe n is a downlink subframe in the primary TDD configuration and an uplink subframe in the secondary TDD configuration, then the electronic circuitry is configured to determine that the subframe is a downlink subframe. If a downlink transmission is transmitted in a downlink or flexible subframe n, then the receive circuitry is configured to receive corresponding HARQ feedback signaling in an uplink subframe n+k of the secondary TDD configuration, where k is an offset based on HARQ feedback timing of the secondary TDD configuration.

Another aspect of the technology includes a radio terminal configured to communicate with a radio communications network using time division duplex (TDD). The radio terminal has electronic circuitry that is configured to process data for a frame structure that includes one or more downlink subframes preconfigured as a downlink subframe, one or more uplink subframes preconfigured as an uplink subframe, and one or more flexible subframes, where a flexible subframe is dynamically allocated to be an uplink subframe in one instance of a frame and a downlink subframe in another frame instance. The circuitry determines how to interpret or use one or more of the flexible subframes based on a primary TDD configuration of the radio communications network. Receive circuitry is configured to receive information sent by a base station in a flexible subframe. Transmit circuitry is configured to transmit information in an uplink direction using a flexible subframe.

As in the case of the network node, the primary TDD configuration may be a current TDD configuration of the radio communications network and is used at least by legacy UE radio terminals. In addition, if a secondary TDD configuration exists, the radio terminal may in one example embodiment determine how to interpret or use one or more of the flexible subframes based on the primary and secondary TDD configurations. In one example implementation, the secondary TDD configuration may include more downlink subframes as compared to the primary TDD configuration. If the radio communications system is an LTE system, the primary and secondary TDD configurations are included in the existing TDD configurations for LTE.

In a detailed but non-limiting example implementation of the radio terminal, a number of subframe handling rules may be followed. If subframe n is a downlink subframe in the primary and the secondary TDD configuration, the radio terminal electronic circuitry is configured to determine that the subframe is a downlink subframe. If a subframe n is an uplink subframe in the primary and the secondary TDD configuration, the electronic circuitry is configured to determine that the subframe is an uplink subframe. If a subframe n is an uplink subframe in the primary TDD configuration and a downlink subframe in the secondary TDD configuration, the electronic circuitry is configured to determine that the subframe is a flexible subframe. If subframe n is a downlink subframe in the primary TDD configuration and an uplink subframe in the secondary TDD configuration, the electronic circuitry is configured to determine that the subframe is a downlink subframe. If an uplink transmission is transmitted in an uplink or flexible subframe n, the receive circuitry is configured to receive corresponding HARQ feedback signaling in the downlink subframe n+k of the primary TDD configuration, where k is an offset based on HARQ feedback timing of the primary TDD configuration.

Another aspect of the radio terminal concerns HARQ feedback signaling. In one non-limiting example implementation, HARQ feedback signaling for a downlink transmission from the radio network in a downlink or flexible subframe is transmitted to the radio network only in an uplink subframe and not in a flexible subframe. In another non-limiting example implementation, the electronic circuitry is configured so that HARQ feedback signaling for a downlink transmission from the radio network in a downlink or flexible subframe is transmitted to the radio network in a flexible subframe.

As another non-limiting example aspect, the radio terminal may transmit one or more of: signaling for radio terminal channel-status reports, signaling for radio terminal uplink scheduling requests, and radio terminal random access attempt signaling according to one or more uplink subframe, downlink subframe, and flexible subframe configurations for an uplink frame. Preferably, the electronic circuitry is configured to avoid making and/or reporting radio signal quality measurements on received flexible subframes.

Another aspect of the technology includes a method for communicating using subframes in a radio communications network that uses time division duplex (TDD) communications between a radio network node and a radio terminal. One or both of the radio network node and the radio terminal performs the steps of:
1-processing data for a frame structure that includes one or more downlink subframes preconfigured as a downlink subframe, one or more uplink subframes preconfigured as an uplink subframe, and one or more flexible subframes, where a flexible subframe is dynamically allocated to be an uplink subframe in one instance of a frame and a downlink subframe in another frame instance;
2-determining how to interpret or use one or more of the flexible subframes based on a primary TDD configuration of the radio communications network;
3-receiving information sent in a flexible subframe; and
4-transmitting information in an uplink direction using a flexible subframe.
   If radio communications network includes a secondary TDD configuration, then the determining step may be based on the primary and secondary TDD configurations.

### BRIEF DESCRIPTION OF THE DRAWINGS

FIG. 1 illustrates frequency division duplex, half-duplex frequency division, and time division duplex transmissions.

FIG. 2 illustrates uplink/downlink time/frequency structure for LTE separately in the case of frequency division duplex (FDD) and time division duplex (TDD).

FIG. 3 is a diagram illustrating as a non-limiting example with seven different downlink/uplink configurations for time division duplex (TDD) in Long Term Evolution (LTE).

FIG. 4 illustrates an example of uplink/downlink (UL/DL) interference in time division duplex (TDD).

FIG. 5 illustrates a non-limiting example radio frame that includes downlink, uplink, and flexible subframes.

FIG. 6 shows an example of hybrid-ARQ (HARQ) timing.

FIG. 7 is a flowchart illustrating non-limiting, example procedures for a radio network node in a communications system employing flexible subframes.

FIG. 8 is a flowchart illustrating non-limiting, example procedures for a UE terminal in a communications system employing flexible subframes.

FIG. 9 is a non-limiting example function block diagram of an LTE cellular communications network in which flexible subframes can be used and in which inter-cell coordination messages may be sent between eNBs over the X2 interface;

FIG. 10 is an example of HARQ timing with flexible subframes.

FIG. 11 is a non-limiting example illustrating HARQ feedback timing according to a secondary TDD configuration compared to a primary TDD configuration.

FIG. 12 is a non-limiting example illustrating HARQ feedback timing according to a primary TDD configuration.

FIG. 13 is a non-limiting example illustrating HARQ feedback timings for a downlink transmission.

FIG. 14 is a non-limiting example illustrating of random access subframes overriding the subframe type configuration.

FIGS. 15A and 15B are non-limiting example function block diagrams of a base station and a UE terminal for use in a communications network in which flexible subframes as described herein or encompassed hereby can be utilized.

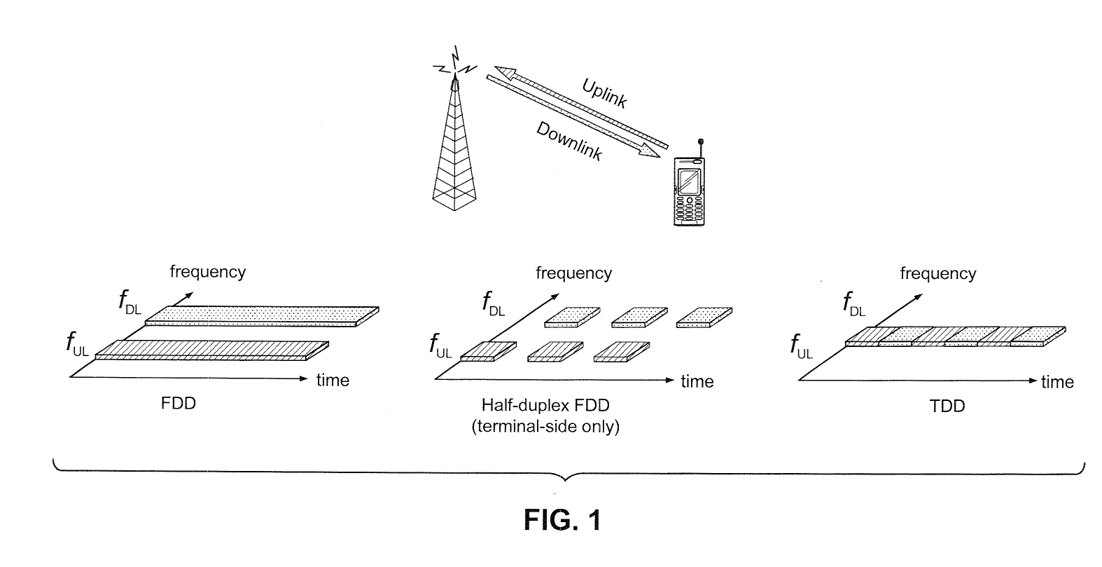

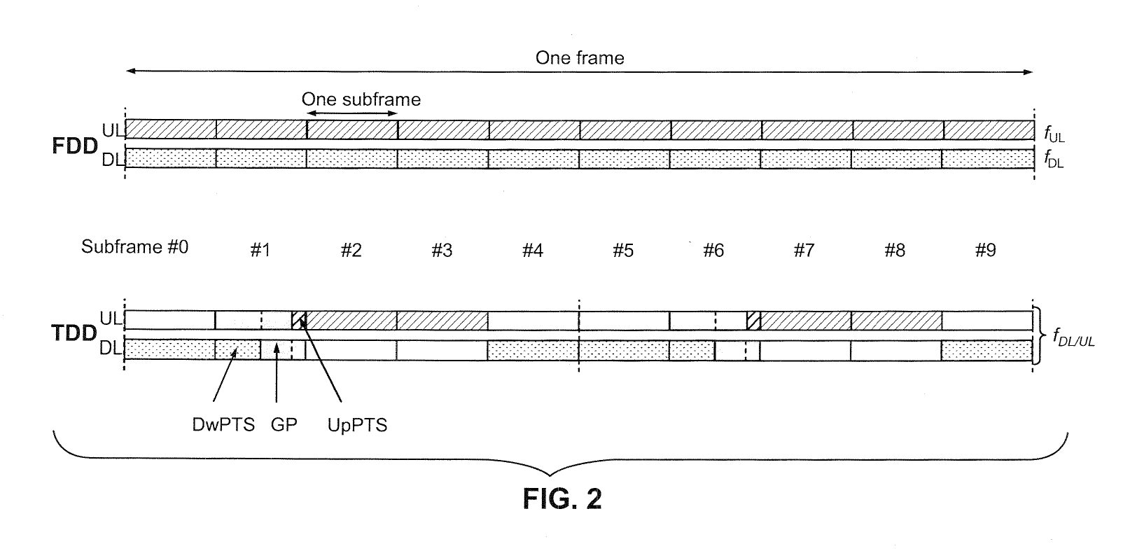

### DETAILED DESCRIPTION

In the following description, for purposes of explanation and not limitation, specific details are set forth such as particular architectures, interfaces, techniques, etc. However, it will be apparent to those skilled in the art that the technology described here may be practiced in other embodiments that depart from these specific details. That is, those skilled in the art will be able to devise various arrangements which, although not explicitly described or shown herein, embody the principles of the technology described and are included within its spirit and scope. In some instances, detailed descriptions of well-known devices, circuits, and methods are omitted so as not to obscure the description with unnecessary detail. All statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “computer”, “processor” or “controller” may be provided through the use of dedicated hardware as well as hardware capable of executing software in the form of coded instructions stored on computer readable medium. A computer is generally understood to comprise one or more processors and/or controllers, and the terms computer and processor may be employed interchangeably herein. When provided by a computer or processor, the functions may be provided by a single dedicated computer or processor, by a single shared computer or processor, or by a plurality of individual computers or processors, some of which may be shared or distributed. Such functions are to be understood as being computer-implemented and thus machine-implemented. Moreover, use of the term “processor” or “controller” shall also be construed to refer to other hardware capable of performing such functions and/or executing software, and may include, without limitation, digital signal processor (DSP) hardware, reduced instruction set processor, hardware (e.g., digital or analog) circuitry, and (where appropriate) state machines capable of performing such functions.

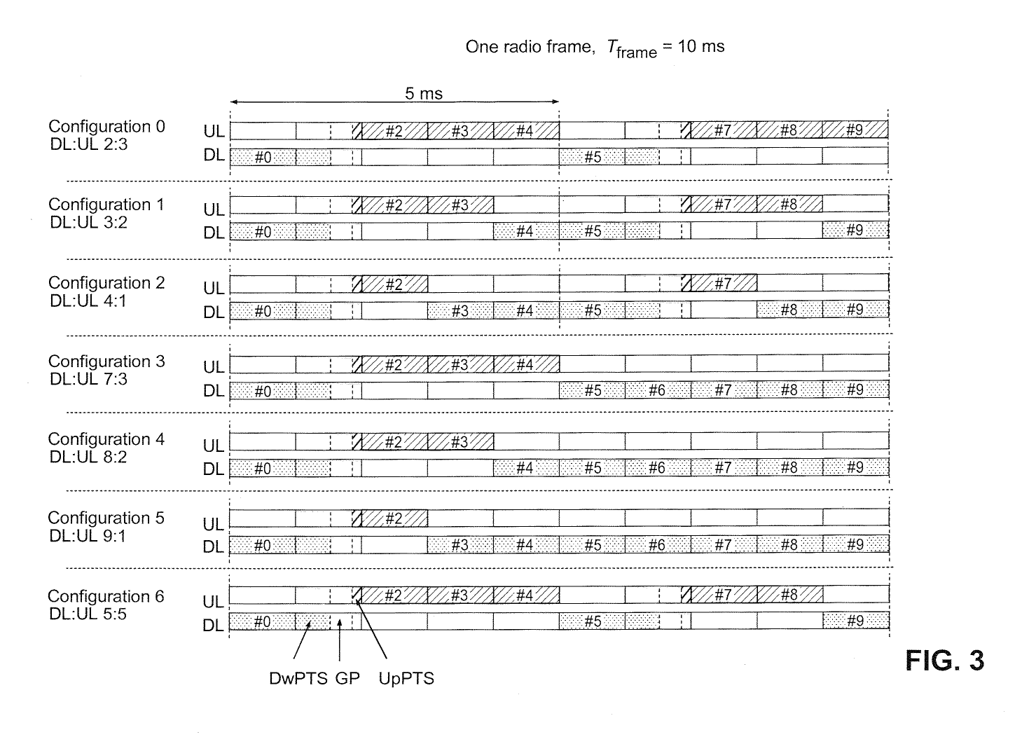

The technology in this application introduces flexible subframes where one or more subframes is flexible because they are not declared or configured in advance as being an uplink subframe or a downlink subframe. This technology is advantageous for example in time division duplex (TDD) based systems. In other words, a flexible subframe can be used for uplink or downlink transmissions as needed or desired. Rather than each subframe in a radio frame being explicitly designated as DL, UL or flexible is to use one or more existing TDD configurations to make the subframe determination. In LTE, there are seven different TDD configurations as shown in FIG. 3 above. These LTE configurations are referred to in examples below. But it is understood that these examples are non-limiting and that any set of TDD configurations could be used.

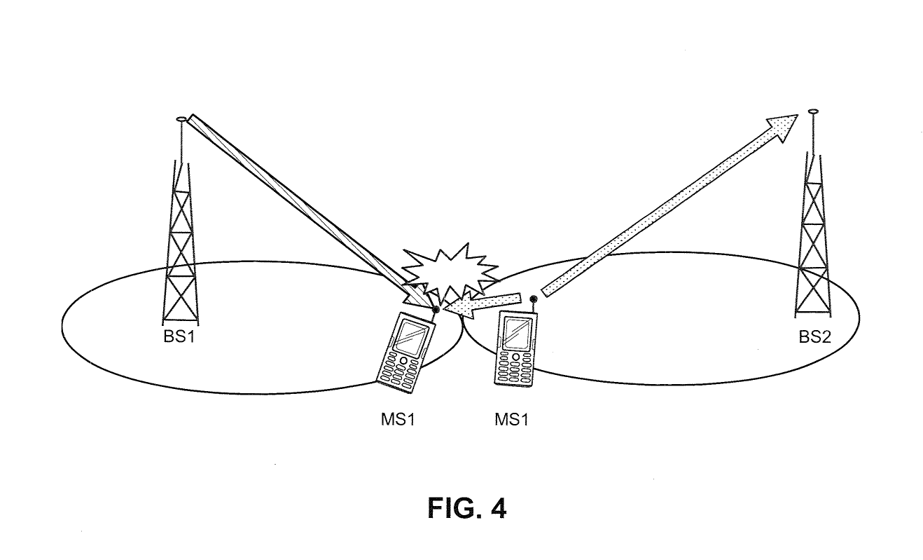

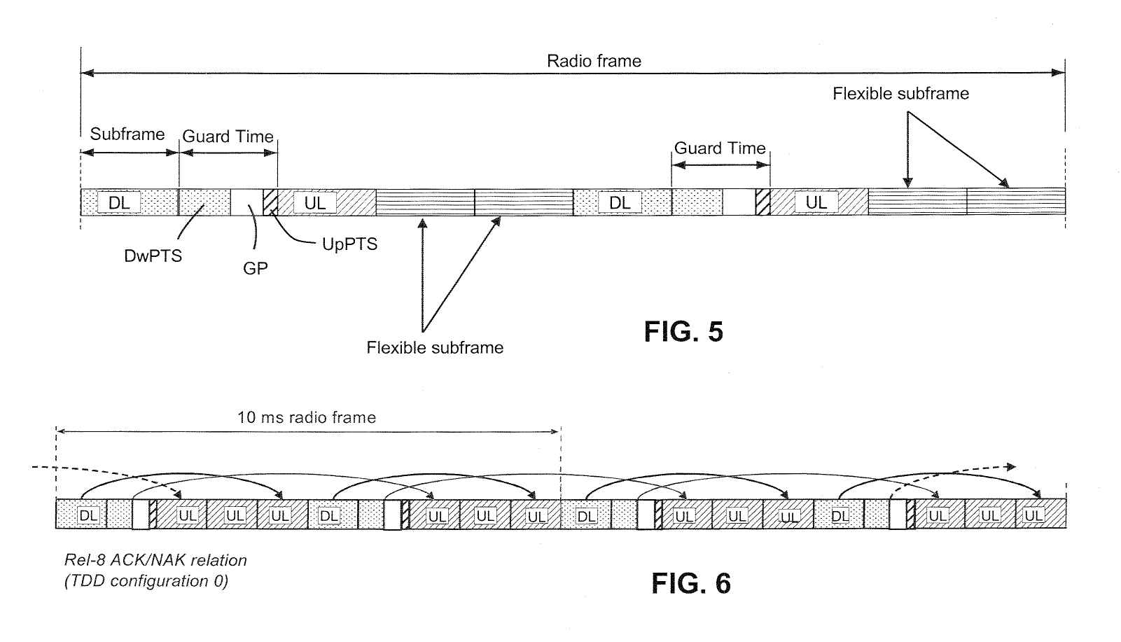

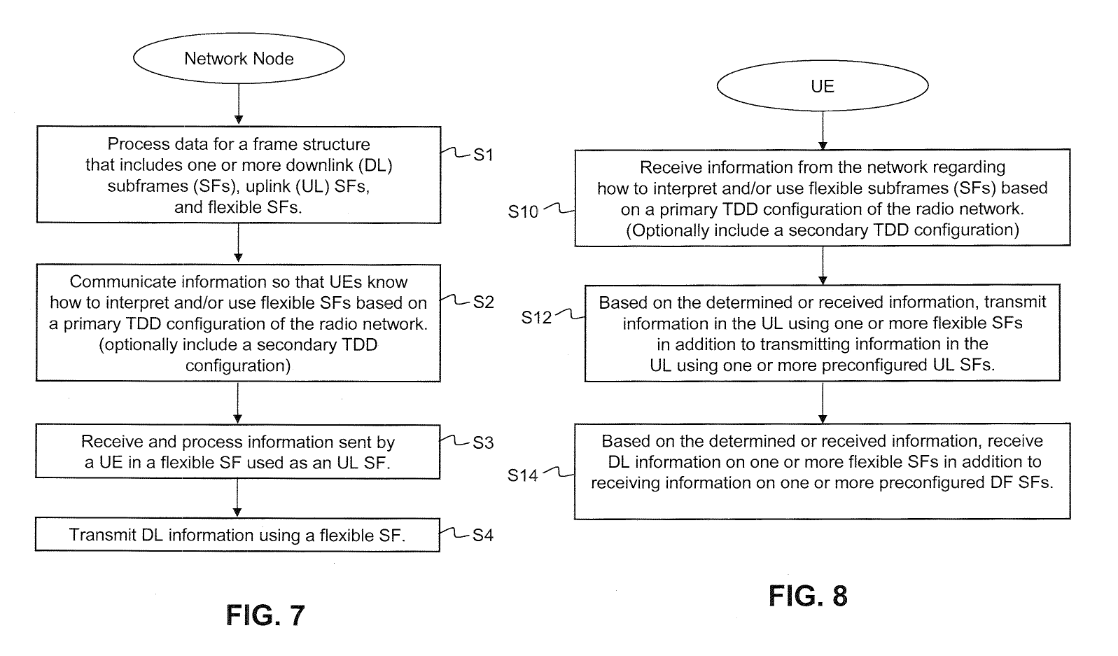

FIG. 7 is a flowchart illustrating non-limiting, example procedures for a radio network node, e.g., a base station, in a communications system employing flexible subframes. Initially, the base station processes data for or from a frame structure that includes one or more downlink subframes, uplink subframes, and flexible subframes (step S1). The radio network node preferably may exchange with neighboring cells information about intended usage of flexible subframes, e.g., to avoid inter-cell interference like that in the example shown in FIG. 4. The radio network node determines how to interpret and/or use flexible subframes based on a primary TDD configuration of the radio network or based on a primary and a secondary TDD configuration (step S2). Alternatively, the radio network node may receive that flexible subframe use information from some other node in the network or even from the UE it is communicating with. Eventually, the radio network node receives and processes information sent by a UE in a flexible subframe used as an uplink subframe (step S3). Also eventually, the radio network node station sends downlink information in a flexible subframe (step S4).

FIG. 8 is a flowchart illustrating non-limiting, example procedures for a UE radio terminal in a communications system employing flexible subframes. Initially or on an ongoing basis, the UE receives information from the network (from or via a base station) regarding how to interpret and/or use flexible subframes based on a primary TDD configuration of the radio network or based on a primary and a secondary TDD configuration (step S10). Based on the determined and/or received information, the UE transmits information in the uplink using one or more flexible subframes in addition to transmitting information in the uplink using one or more preconfigured uplink subframes (step S12). Also, based on the determined and/or received information, the UE receives information in the downlink on one or more flexible subframes in addition to receiving information in the downlink on one or more preconfigured downlink subframes (step S14).

In one non-limiting example embodiment using the LTE configurations shown in FIG. 3 above, a primary TDD configuration is determined from one of the seven (7) TDD configurations defined by 3GPP. This primary TDD configuration corresponds to the current TDD configuration and is used at least by legacy UE terminals. A secondary TDD configuration, also potentially being one of the 7 existing TDD configurations, is determined in this non-limiting example embodiment. In a preferred but non-limiting example, the secondary TDD configuration has more downlink subframes than the primary TDD configuration.

In this embodiment, DL, UL, and flexible subframes may be determined using the following non-limiting example four (4) rules:
1—If subframe n is a DL subframe in the primary and the secondary TDD configurations, then the subframe is determined as a DL subframe.
2—If subframe n is an UL subframe in the primary and secondary TDD configurations, then the subframe is determined as a UL subframe.
3—If the subframe n is an UL subframe in the primary configuration, but a DL subframe in the secondary configuration, then the subframe n is a flexible subframe.
4—If the subframe n is a DL subframe in the primary TDD configuration, but an UL subframe in the secondary TDD configuration, then there are three alternatives: the subframe is a DL, UL, or flexible subframe. The first alternative ensures that legacy UEs using the primary TDD configuration do not suffer from the absence of CRS and other DL signals. The second alternative is beneficial for HARQ feedback timing in some cases. The third alternative gives more flexibility to allocate resources between UL and DL. In one non-limiting example, the first alternative may be preferred.

As an example, let Configuration 0 in FIG. 3 be the primary TDD configuration and Configuration 2 be the secondary TDD configuration. Based on the principles above, the subframes #0, #1, #5 and #6 are DL (or special guard frames) subframes, subframes #2 and #7 are UL subframes, and subframes #3, #4, #8, and #9 are flexible subframes.

The case where subframe n is DL in the primary configuration, but UL in the secondary configuration, is present only for certain selections of the configurations, e.g., when the primary TDD configuration is Configuration 1 and the secondary configuration is Configuration 3 in FIG. 3. To avoid problems in HARQ feedback timing described below, it may be preferable to avoid these combinations.

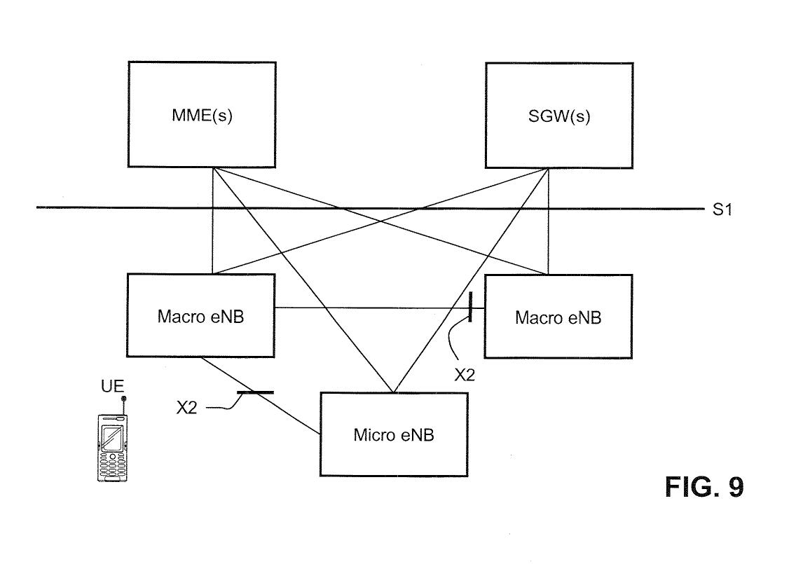

With respect to inter-cell communication/coordination, one way of accomplishing it is as an extension of inter-cell interference coordination provided already in LTE Rel-8. InterCell Interference Coordination (ICIC) in LTE Rel-8 relies on the base stations exchanging messages over the X2 interface. FIG. 9 shows an example diagram of an LTE-based communications system. The core network nodes include one or more Mobility Management Entities (MMEs), a key control node for the LTE access network, and one or more Serving Gateways (SGWs) which route and forward user data packets while and acting as a mobility anchor. They communicate with base stations, referred to in LTE as eNBs, over an S1 interface. The eNBs can include macro and micro eNBs that communicate over an X2 interface. These inter-cell communication/coordination messages are suggestions from one base station to another base station, possibly influencing the scheduling and/or UL and/or DL transmission. Typically these recommendations are valid until further notice. An extension to the inter-cell communication/coordination message may be added to account for flexible subframes, e.g., indicating that the suggestion is for a specific flexible subframe.

Allocating some subframes to be flexible and dynamically allocating some flexible subframes for uplink and downlink transmissions also benefits control signaling design. In many systems, data received in one transmission direction should be acknowledged by transmitting a signal in the other direction. One non-limiting example of this is ARQ messages, e.g., hybrid-ARQ (HARQ) acknowledgements in LTE. Since uplink transmissions cannot occur in downlink subframes, (and vice versa), hybrid-ARQ acknowledgements are typically “postponed” until the next possible uplink subframe.

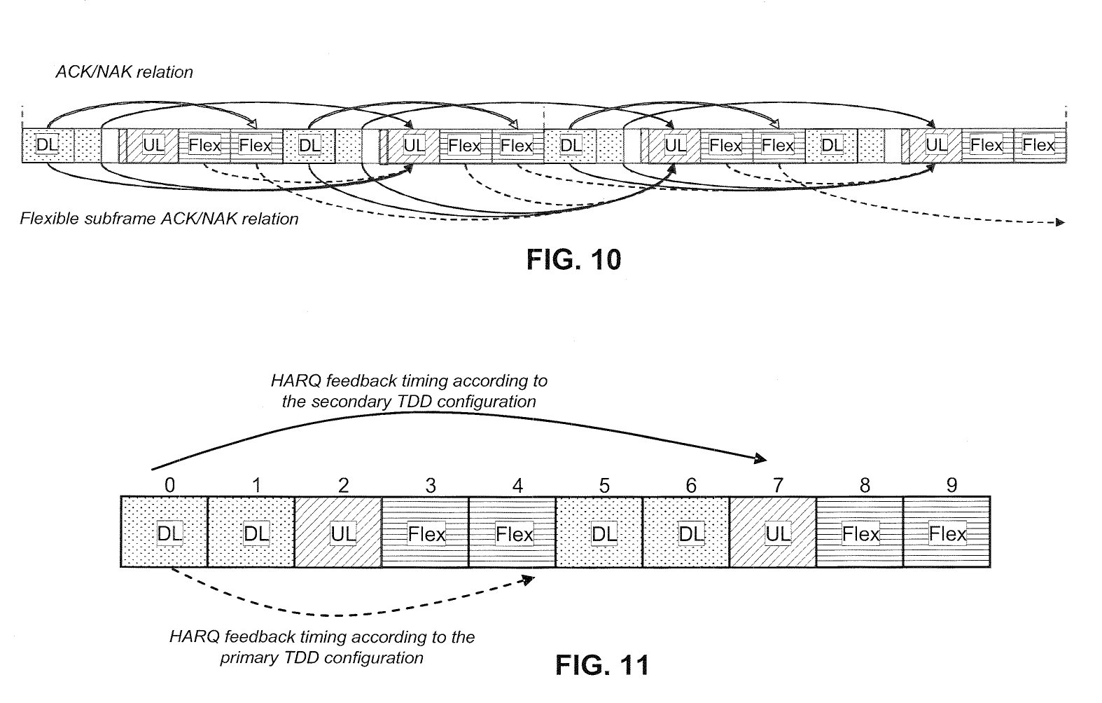

With the introduction of flexible subframes, the timing of the ARQ acknowledgements needs to be considered. One question is whether hybrid-ARQ acknowledgements should be transmitted in flexible subframes or not. These two cases are illustrated in FIG. 10, where the arrows above the subframes illustrate the case of directly reusing the LTE HARQ Rel-8 timing relation so that acknowledgements sometimes are transmitted in flexible subframes and sometimes in UL subframes. The arrows below illustrate a case where acknowledgements are transmitted in UL subframes only. Even though FIG. 10 illustrates acknowledgements transmitted in the uplink in response to downlink data transmission, a similar illustration can be drawn for the UL direction.

Although it is possible for feedback signaling like HARQ messages to only transmitted in UL subframes for DL transmissions and only in DL subframes for UL transmissions, this approach may not be optimal for existing or desired HARQ timing. For example, 3GPP TS 36.312 incorporated herein by reference specifies HARQ timing where the feedback transmission time is based on predefined tables and does not occur necessarily in the earliest possible subframe subject to the processing delay. An alternative approach that is more compatible for existing 3GPP HARQ timing is now described. A UE receiving a DL transmission in a DL or flexible subframe n, transmits the HARQ feedback in the UL subframe n+k of the secondary TDD configuration, where the offset k is based on the HARQ feedback timing of the secondary TDD configuration. See Table 10.1.-1 in 3GPP TS 36.213 incorporated herein by reference. For a UE needing to transmit an UL transmission in an UL or flexible subframe n, the UE will receive the corresponding feedback in the DL subframe n+k of the primary TDD configuration, where the offset k is based on the HARQ feedback timing of the primary TDD configuration. See Table 8.3-1 in 3GPP TS 36.213.

FIG. 11 shows an example DL transmission where the HARQ feedback timing according to the secondary TDD configuration (Conf 2) is compared to the timing with the primary configuration (Conf 0) from the TDD configurations in FIG. 3. Based on the HARQ timing of the primary configuration, the HARQ feedback as a response to the transmission in subframe #0 would occur in subframe #4. However, when the secondary HARQ timing is used, the feedback occurs in subframe #7. A benefit of moving the HARQ feedback later is that scheduling of the flexible subframe 4 either for DL or UL is not impacted by the possible HARQ feedback signaling occurrence.

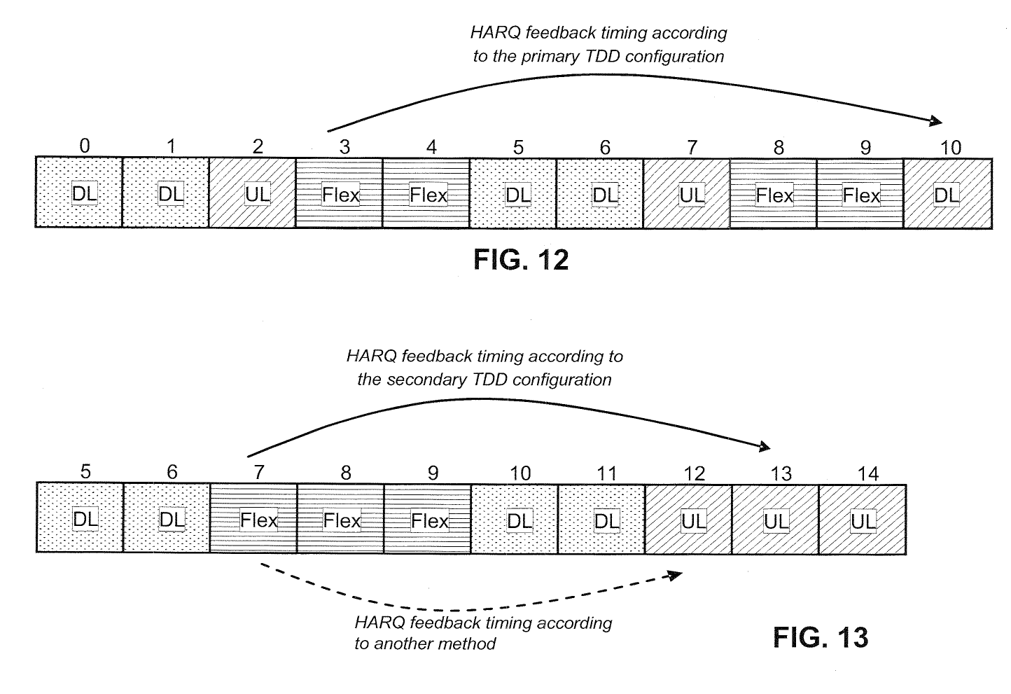

FIG. 12 shows an example UL transmission based on the HARQ timing of the primary configuration (Conf 0). The HARQ feedback response for the uplink transmission in subframe #3 occurs in DL subframe #10.

FIG. 13 shows a comparison of HARQ feedback timing for a DL transmission for the proposed approach described above (solid arrow in figure) and another approach (dashed arrow in figure) outlined in commonly-assigned U.S. patent application Ser. No. 12/816,821 (“other approach”) which produce different HARQ feedback timings in some scenarios. Again, referring to FIG. 3, consider TDD configuration 0 as the primary configuration and the TDD configuration 3 as the secondary configuration. With the other approach, the HARQ feedback response to the DL transmission is transmitted in the closest semi-statistically configured UL subframe (subframe #12). In the proposed approach, the feedback is transmitted in the subframe #13 according to the HARQ timing tables of the secondary TDD configuration. A benefit of the proposed approach is that the HARQ feedbacks are better spread over many UL subframes, and the performance loss due to ACK/NACK bundling is reduced.

The HARQ feedback transmission in the UL in response to a flexible subframe transmission in the DL can occur in the same UL subframe as the HARQ feedback transmission in a normal DL subframe. In order to be able to receive both feedback signals, the eNodeB may need to allocate different PUCCH resources for LTE Rel-8 and other UEs, e.g., by configuring different PUCCH offsets by higher layers.

The UE feedback transmission in the UL as a response to a DL transmission can collide with a flexible subframe used for DL transmission. One example solution to this problem is to configure UEs to perform HARQ message repetition. With such repetition, at least some of the repeated ACK/NACKs will be an UL subframe and thus detected by an eNodeB.

There may be some specific cases where the above-described rules for the HARQ feedback timing may not be applicable. For example, consider a situation where a given subframe is DL in the primary TDD configuration and UL in the secondary configuration. If alternative 1 in rule 4 above is used for the four rules described above, this subframe is selected as a DL subframe. But the HARQ feedback timing based on the secondary configuration is not possible because the subframe is not DL in the secondary configuration and timing is not defined. In this case, alternative rules can be applied.

Acknowledgements can also be allowed in flexible subframes. This approach has the benefit of not introducing additional delay as compared for example to LTE Rel-8. However, this approach may reduce the flexibility in using flexible subframes because the transmission of an acknowledgement in one direction implies that the flexible subframe cannot be used for data transmission in the other direction. Furthermore, this approach can also lead to misalignment between the eNodeB and the UE about the transmission direction used in a flexible subframe, as will now be described.

To illustrate misalignment of the transmission direction, assume that a UE misses an uplink scheduling grant relating to flexible subframe n from an eNodeB. Thus, the UE is not aware that subframe n was scheduled in the uplink direction, and instead, the UE may expect an acknowledgement from a previous uplink transmission to be received in subframe n. The eNodeB, on the other hand, expects UL data transmission from the UE in flexible subframe n and will thus not transmit any acknowledgement. Since the eNodeB will not transmit any acknowledgement even though the UE is expecting one, the UE may or may not decide on a negative acknowledgement based on a missing signal, which may lead to unpredictable behavior. If the UE concludes that the acknowledgement was negative, the UE will initiate a retransmission in a later subframe, possibly a flexible subframe. In this case, the UE may not listen for downlink control signaling in that particular subframe. Hence, since the direction (uplink or downlink) of one flexible subframe affects the usage (uplink or downlink) of another flexible subframe, these kinds of errors can propagate.

One way to mitigate such error propagation and still allow flexible subframes to be used for uplink transmission of hybrid-ARQ acknowledgements in response to downlink transmissions is to configure ACK/NAK-repetition in the UEs. UEs receiving data in the downlink transmit the acknowledgement repeated across two or more (consecutive or non-consecutive) subframes (UL or flexible). As long as at least one of the subframes carrying the acknowledgement is an UL subframe, the eNodeB has a high likelihood of receiving the acknowledgement. In flexible subframes, the eNodeB may receive the acknowledgement if the flexible subframe was used in the uplink direction. Hence, sometimes the eNodeB receives the acknowledgement in a flexible subframe, which can be beneficial from a delay perspective, while in other cases, the flexible subframe is used for downlink transmissions and the eNodeB cannot receive the acknowledgement until it has been repeated in an UL subframe as well. Although this approach combines reliable acknowledgement reception with a reduced delay in some cases, it comes at the cost of increased overhead because the acknowledgements must be repeated across multiple subframes and may limit the downlink scheduling flexibility.

In LTE, the uplink grants are carried in the DL on the physical downlink control channel (PDCCH) to indicate to the UE when to perform a UL transmission. In 3GPP TS 36.213, there is a specific timing table for TDD when a received grant in the DL is valid for transmission in the UL. The grant timing of the primary TDD configuration may be used for UL subframes because none of the DL subframes of the primary TDD configuration can be a flexible subframe when the DL/UL/flexible subframe definition is based on the four rules described above using the preferred alternative in rule 4. But if other alternatives are used for rule 4, then the UL grant timing should defined separately.

Possible synchronous UL subframe retransmission may need to be taken into account when scheduling flexible subframes for uplink or downlink. If it is not known early enough that the UL subframe retransmission is needed, then it can be efficient to use a method called HARQ suspension. In a HARQ suspension approach, the pending uplink process is suspended by an ACK on the physical hybrid ARQ indicator channel (PHICH), a flexible subframe is scheduled for downlink transmission, and then the uplink retransmission is done one HARQ round trip time (RTT) later.

In addition to hybrid-ARQ acknowledgements, LTE also supports feedback of channel-status reports and scheduling requests in the uplink. The occasions when this may occur in LTE is semi-statically configured via RRC signaling. System configuration may therefore be used to ensure that these types of feedback occur in UL subframes only. Alternatively, this type of feedback can be configured to occur in flexible subframes as well, although the overall system operation (including scheduling) has to handle issues similar to those for HARQ acknowledgements in flexible subframes as described above. Random-access attempts may in LTE only occur at preconfigured time instances and is from a flexible perspective similar to channel-status reports and scheduling requests, i.e., proper system configuration can be used.

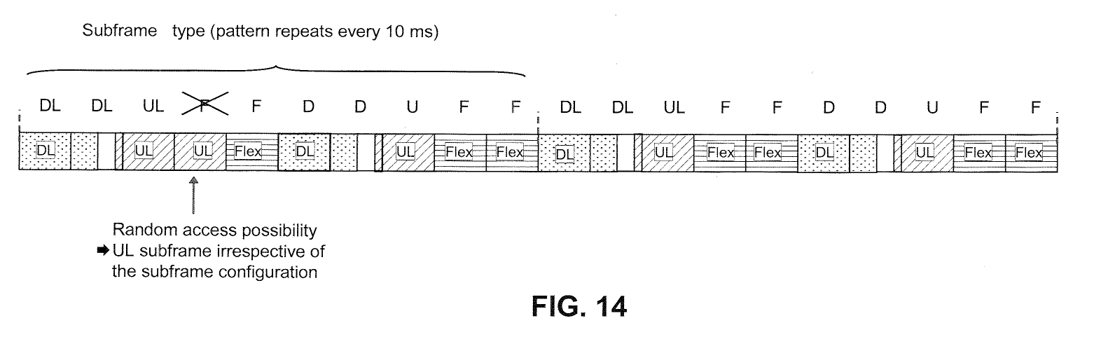

Common for all of these types of subframe information, (channel-status reports, scheduling requests, and random-access attempts), is that where the subframes may occur is semi-statically configured. However, the periodicity of those subframes is not necessarily a multiple of (or a factor in) the radio frames. Hence, different UL/DL/flexible configurations in different radio frames may be useful. This can be achieved in multiple ways. One example is to explicitly configure the subframe types differently in different radio frames. Alternatively, the configuration of the subframes where random access is allowed can override the underlying subframe type, (e.g., for LTE, configured on a 10 ms radio frame basis). If random access is allowed in a subframe, then the subframe should be viewed as an UL subframe, even if the subframe type configuration indicates differently as illustrated in FIG. 14.

Another consideration relates to the UE measurements of DL signals for channel quality estimation and mobility purposes. To get correct measurements, the UE should preferably make the measurements only in the subframes that are known to be DL subframes. Even if a particular UE is not scheduled for some flexible subframe in the UL, some other UE may well be. Preferably, the UE does not perform DL measurements in a UL subframe because such measurements may lead to an erroneous channel quality estimation.

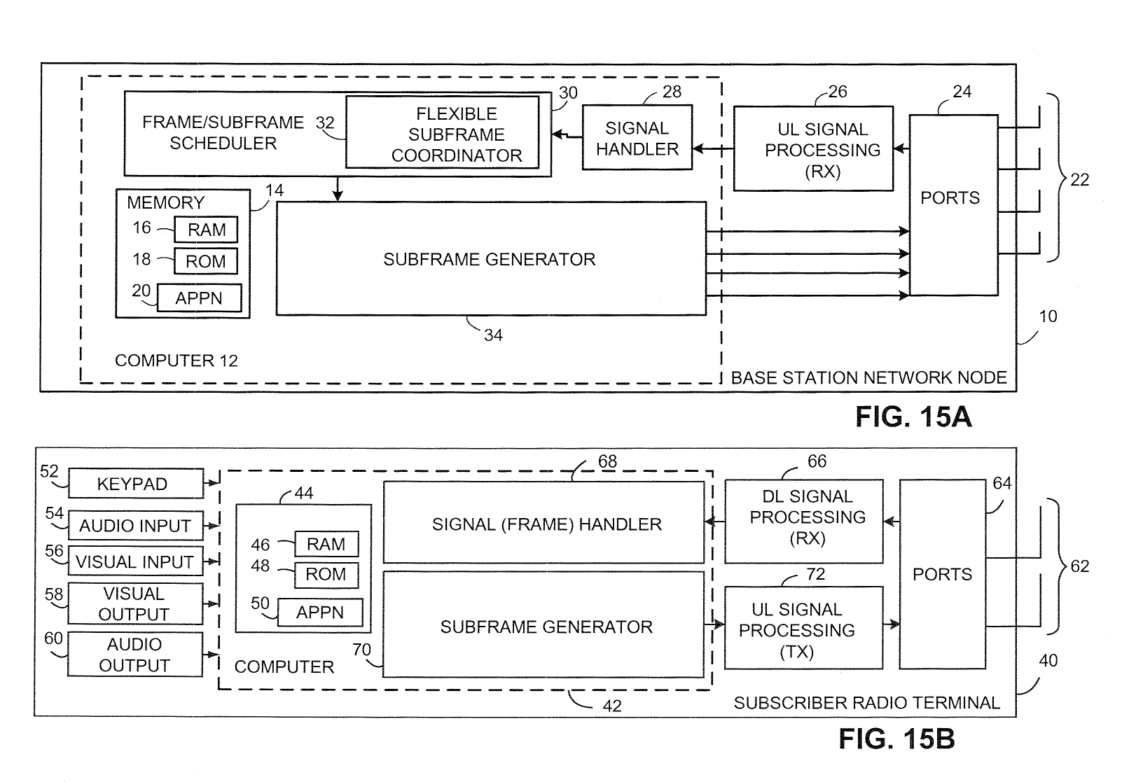

FIG. 15A shows an example base station node 10 in which flexible subframes as described herein or encompassed hereby can be utilized. The base station 10 communicates with one or more UE terminals 40 over an air interface and includes a frame/subframe scheduler 30 which controls operation of a subframe generator 34. The subframe generator 34 is configured to format and compose subframes which are transmitted on a downlink from base station 10 to the UE terminal 40. The frame/subframe scheduler 30 also includes a flexible subframe coordinator 32 which is configured to allocate flexible subframes according to one or more of the non-limiting example embodiments described above. Using the flexible subframe coordinator 32, the frame/subframe scheduler 30 determines which subframes of a frame are to be designated as flexible subframes, and controls signaling so that both base station and UE radio terminal understand which subframes are flexible subframes.

The base station also includes typical base station hardware like antennas 22 connected to the base station node via antenna ports 24. Received signals are processed in uplink signal processing circuitry 26 to convert the received signal to baseband. The signal handler 28 extracts frames from the received baseband signal for processing by the frame/subframe scheduler 32. The frame/subframe scheduler 30, flexible subframe coordinator 32, and subframe generator 34 can be computer-implemented, e.g., by one or more processor(s) or controller(s). A computer 12 is shown with a memory 14 that includes RAM 16, ROM 18, and application programs 20.

The UE radio terminal 40 in FIG. 15B includes a subframe generator 70 so that UE radio terminal 40 can generate subframes on the uplink (UL) for those frames which are understood to be uplink (UL) subframes, either by semi-permanent designation or as being flexible subframes which are understood from determination, signaling, or otherwise are to be used for uplink (UL) transmission. The subframes from the subframe generator 70 are provided to uplink processing circuitry to convert the baseband information into an RF signal which is routed via one or more port 64 to one or more antennas 62 for transmission over the air interface to the base station 10. Downlink signals are received via the one or more antennas 62 and conveyed via the one or more ports 64 to downlink signal processing circuitry that converts the RF signal into baseband. The baseband signal is then provided to signal frame handler 68 for downlink subframe processing in accordance with preconfigured downlink subframes and those flexible subframes designated or assumed to be downlink subframes.

The signal frame handler 68 and subframe generator 70 can be computer-implemented, e.g., by one or more processor(s) or controller(s). A computer 42 is shown with a memory 44 that includes RAM 46, ROM 48, and application programs 50. The UE radio terminal may also include typical user interface components like a keypad 52, audio input 54, visual input 56, visual output 58, and audio output 60.

Example benefits and usage scenarios for flexible subframes include but are not limited to flexible UL/DL asymmetry, measurement operations, UE-to-UE communication, and base station discontinuous transmission (DTX). The technology described herein makes dynamic downlink/uplink subframe allocation possible in TDD. Efficient solutions for feedback transmissions when using flexible subframes are provided. Moreover, the dynamic allocation of uplink and downlink resources can be matched to the traffic load so that scarce radio resources are used effectively.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology described here, for it to be encompassed by the present claims. No claim is intended to invoke paragraph 6 of 35 USC §112 unless the words “means for” or “step for” are used. Furthermore, no embodiment, feature, component, or step in this specification is intended to be dedicated to the public regardless of whether the embodiment, feature, component, or step is recited in the claims.

1. A radio network node for use in a radio communications network using time division duplex (TDD) to communicate with user equipment (UE) radio terminals, comprising:
electronic circuitry configured to:
process data for a frame structure that includes one or more subframes preconfigured as downlink subframe, one or more subframes preconfigured as uplink subframes, and one or more flexible subframes each dynamically allocated to be an uplink subframe in one instance and a downlink subframe in another instance, and
determine how to interpret or use one or more of the flexible subframes based on a primary TDD configuration of the radio communications network;
radio receive circuitry configured to receive information sent by the radio terminal in a flexible subframe; and
radio transmit circuitry configured to transmit information in a downlink direction using a flexible subframe.

2. The radio network node in claim 1, wherein the primary TDD configuration is a current TDD configuration of the radio communications network and is used at least by legacy UE radio terminals.

3. The radio network node in claim 1, wherein the radio communications network includes a secondary TDD configuration and the electronic circuitry is configured to determine how to interpret or use one or more of the flexible subframes based on the primary and secondary TDD configurations.

4. The radio network node in claim 3, wherein the secondary TDD configuration includes more downlink subframes as compared to the primary TDD configuration.

5. The radio network node in claim 3, wherein the radio communications system is an LTE system and the primary and secondary TDD configurations are included in the existing TDD configurations for LTE.

6. The radio network node in claim 3, wherein if subframe n is a downlink subframe in the primary and the secondary TDD configuration, the electronic circuitry is configured to determine that the subframe is a downlink subframe, and wherein if subframe n is an uplink subframe in the primary and the secondary TDD configuration, the electronic circuitry is configured to determine that the subframe is an uplink subframe.

7. The radio network node in claim 3, wherein if subframe n is an uplink subframe in the primary TDD configuration and a downlink subframe in the secondary TDD configuration, the electronic circuitry is configured to determine that the subframe is a flexible subframe.

8. The radio network node in claim 3, wherein if subframe n is a downlink subframe in the primary TDD configuration and an uplink subframe in the secondary TDD configuration, the electronic circuitry is configured to determine that the subframe is a downlink subframe.

9. The radio network node in claim 3, wherein if a downlink transmission is transmitted in a downlink or flexible subframe n, the receive circuitry is configured to receive corresponding HARQ feedback signaling in an uplink subframe n+k of the secondary TDD configuration, where k is an offset based on HARQ feedback timing of the secondary TDD configuration.

10. The radio network node in claim 1, wherein the electronic circuitry is configured to use a grant timing of the primary TDD configuration for uplink subframes.

11. A radio terminal configured to communicate with a radio communications network using time division duplex (TDD), comprising:
electronic circuitry configured to:
process data for a frame structure that includes one or more downlink subframes preconfigured as a downlink subframe, one or more uplink subframes preconfigured as an uplink subframe, and one or more flexible subframes, where a flexible subframe is dynamically allocated to be an uplink subframe in one instance of a frame and a downlink subframe in another frame instance, and
determine how to interpret or use one or more of the flexible subframes based on a primary TDD configuration of the radio communications network;
receive circuitry configured to receive information sent by a base station in a flexible subframe; and
transmit circuitry configured to transmit information in an uplink direction using a flexible subframe.

12. The radio terminal in claim 11, wherein the primary TDD configuration is a current TDD configuration of the radio communications network and is used at least by legacy UE radio terminals.

13. The radio terminal in claim 11, wherein the radio communications network includes a secondary TDD configuration and the electronic circuitry is configured to determine how to interpret or use one or more of the flexible subframes based on the primary and secondary TDD configurations.

14. The radio terminal in claim 13, wherein the secondary TDD configuration includes more downlink subframes as compared to the primary TDD configuration.

15. The radio terminal in claim 13, wherein the radio communications system is an LTE system and the primary and secondary TDD configurations are included in the existing TDD configurations for LTE.

16. The radio terminal in claim 13, wherein if subframe n is a downlink subframe in the primary and the secondary TDD configuration, the electronic circuitry is configured to determine that the subframe is a downlink subframe, and wherein if subframe n is an uplink subframe in the primary and the secondary TDD configuration, the electronic circuitry is configured to determine that the subframe is an uplink subframe.

17. The radio terminal in claim 13, wherein if subframe n is an uplink subframe in the primary TDD configuration and a downlink subframe in the secondary TDD configuration, the electronic circuitry is configured to determine that the subframe is a flexible subframe.

18. The radio terminal in claim 13, wherein if subframe n is a downlink subframe in the primary TDD configuration and an uplink subframe in the secondary TDD configuration, the electronic circuitry is configured to determine that the subframe is a downlink subframe.

19. The radio terminal in claim 13, wherein if an uplink transmission is transmitted in an uplink or flexible subframe n, the receive circuitry is configured to receive corresponding HARQ feedback signaling in the downlink subframe n+k of the primary TDD configuration, where k is an offset based on HARQ feedback timing of the primary TDD configuration.

20. The radio network node in claim 13, wherein the electronic circuitry is configured so that HARQ feedback signaling for a downlink transmission from the radio network in a downlink or flexible subframe is transmitted to the radio network only in an uplink subframe and not in a flexible subframe.

21. The radio terminal in claim 13, wherein the electronic circuitry is configured so that HARQ feedback signaling for a downlink transmission from the radio network in an downlink or flexible subframe is transmitted to the radio network in a flexible subframe.

22. The radio terminal in claim 11, wherein the electronic circuitry is configured to transmit one or more of: signaling for radio terminal channel-status reports, signaling for radio terminal uplink scheduling requests, radio terminal random access attempt signaling according to an uplink subframe, downlink subframe, and flexible subframe configuration for an uplink frame.

23. The radio terminal in claim 11, wherein the electronic circuitry is configured to avoid making and/or reporting radio signal quality measurements on received flexible subframes.

24. A method for communicating using subframes in a radio communications network that uses time division duplex (TDD) communications between a radio network node and a radio terminal, comprising one or both of the radio network node and the radio terminal performing the steps of:
processing data for a frame structure that includes one or more downlink subframes preconfigured as a downlink subframe, one or more uplink subframes preconfigured as an uplink subframe, and one or more flexible subframes, where a flexible subframe is dynamically allocated to be an uplink subframe in one instance of a frame and a downlink subframe in another frame instance;
determining how to interpret or use one or more of the flexible subframes based on a primary TDD configuration of the radio communications network;
receiving information sent in a flexible subframe; and
transmitting information in an uplink direction using a flexible subframe.

25. The method claim 24, wherein the radio communications network includes a secondary TDD configuration, and the determining step is based on the primary and secondary TDD configurations.

26. The method in claim 25, wherein:
if subframe n is a downlink subframe in the primary and the secondary TDD configuration, determining that the subframe is a downlink subframe;
if subframe n is an uplink subframe in the primary and the secondary TDD configuration, determining that the subframe is an uplink subframe;
if subframe n is an uplink subframe in the primary TDD configuration and a downlink subframe in the secondary TDD configuration, determining that the subframe is a flexible subframe; and
if subframe n is a downlink subframe in the primary TDD configuration and an uplink subframe in the secondary TDD configuration, determining that the subframe is a downlink subframe.

27. The radio method in claim 24, further comprising using a grant timing of the primary TDD configuration for uplink subframes.
